(19) United States
(12) Patent Application Publication
(10) Pub. No.: US 2015/0118659 A1
(43) Pub. Date: Apr. 30, 2015

(54) SYSTEMS AND METHODS FOR EVALUATING FOOD PRODUCTS IN A HEALTH-MANAGEMENT CONTEXT

(71) Applicant: Cal Pro Method LLC, San Diego, CA (US)

(72) Inventor: Scott Meyer, San Diego, CA (US)

(21) Appl. No.: 14/526,302

(22) Filed: Oct. 28, 2014

Related U.S. Application Data
(60) Provisional application No. 61/898,363, filed on Oct. 31, 2013.

(51) Int. Cl. G09B 19/00; G09B 5/00; A23L 1/29

(52) U.S. Cl. CPC G09B 19/0092; A23L 1/293; G09B 5/00; A23V 2002/00
USPC 434/127

(57) ABSTRACT

Systems and methods for weight management. In an embodiment, nutritional information for a food product is acquired. The nutritional information may comprise at least a calorie value and a protein value. At least one index value may be computed for the food product based on the calorie value and the protein value. In addition, one or more weight management tools may be provided to a user based on the computed index value.

### CROSS-REFERENCE TO RELATED APPLICATIONS

This application claims priority to U.S. Provisional Patent App. No. 61/898,363, filed on Oct. 31, 2013, the entirety of which is hereby incorporated herein by reference.

### BACKGROUND

1. Field of the Invention

The embodiments described herein are generally directed to evaluating food products, and, more particularly, to utilizing ratios calculated from nutritional information to quickly evaluate health characteristics for a food product in the context of health or weight management.

2. Description of the Related Art

Weight loss and management should incorporate all aspects of a person's life, and include, for instance, exercise, stress reduction, a healthy food selection, lipid and cholesterol management, metabolism management, etc. Nevertheless, the basic formula to weight loss is to take in fewer calories than the body burns. Achievement of this goal is the subject of numerous weight-loss programs. However, there is still room for improvement in the evaluation of food products both within and external to these conventional weight-loss programs.

### SUMMARY

In an embodiment, a method for weight management is disclosed. The method comprises using at least one hardware processor to: acquire nutritional information for a food product, wherein the nutritional information comprises a calorie value and a protein value; computing at least one index value for the food product based on the calorie value and the protein value; and provide one or more weight management tools to a user based on the computed index value.

In an additional embodiment, a system for weight management is disclosed. The system comprises at least one hardware processor; and at least one executable software module that is configured to, when executed by the at least one hardware processor, acquire nutritional information for a food product, wherein the nutritional information comprises a calorie value and a protein value; computing at least one index value for the food product based on the calorie value and the protein value; and provide one or more weight management tools to a user based on the computed index value.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an infrastructure for the disclosed systems and methods, according to an embodiment;

FIG. 2 illustrates a process for health or weight management, according to an embodiment; and

FIG. 3 illustrates a processing system on which one or more of the processes described herein may be executed, according to an embodiment.

### DETAILED DESCRIPTION

In an embodiment, systems and methods are disclosed for utilizing a science-based formula to derive at least one number or index from nutritional information for a food product. This index may be printed on packaging for the food product or derived from information obtained from the packaging or otherwise known about and/or retrieved for the food product (e.g., from a local or remote database). The index can provide a quick and easy method for assessing the nutritional value of the food product. In addition, the index may be utilized for health management, such as weight management.

A person's metabolism is one significant aspect of health or weight management. One measure of metabolism is the basal metabolic rate, which is the rate at which energy is burned when the body is at rest. The metabolic rate can be influenced by a person's diet, exercise, genetics, and lean body mass or fat mass ratio.

Potential features of a desirable diet may include, without limitation:
Increased protein to aid in building lean body mass;
Decreased carbohydrate intake, e.g., by moderating total carbohydrate intake while minimizing simple carbohydrate intake;
Increased fat intake to be used as fuel for energy expenditure, while sparing protein to be used for the building of lean body mass;
Increased fat intake and decreased carbohydrate intake to shift energy utilization to burning fat instead of carbohydrates, while sparing protein for the building of muscle tissue; and/or
Increased fat intake to increase satiety, and therefore, suppress the dieter's appetite for a longer period of time by making the dieter feel full and satisfied after meals and/or snacks, thereby helping to prevent overeating or snacking throughout the day, resulting in decreased caloric intake throughout the day.

Dietary influences include, without limitation, protein, carbohydrate, and fat. Increased protein intake and decreased total carbohydrate intake can result in increased lean body mass. With increased protein intake, a person will subsequently increase his or her overall fat intake. While choosing lean protein sources may be best, fat intake can help to increase overall satiety and assist the body in using fat as a fuel source for daily activities and exercise.

Animal protein is more bioavailable than vegetable protein. This means that the body is able to break down and use animal protein for fuel and lean tissue building more efficiently than vegetable protein. However, vegetable protein is good for building lean tissue and burning energin, even though it takes the body longer to break it down. People who choose a vegetarian diet simply need to be more aware of the other components of their diets (e.g., carbohydrates and fat) in an effort to aid in protein breakdown to is most usable or bioavailable form.

In addition to protein, fat is also an essential part of a diet. Fat protects the organs, helps regulate internal body temperature (e.g., keeps the body warm), aids in reproduction, is the most concentrated fuel source (e.g., provides the most concentrated source of energy for the body to use over long periods of starvation), and increases satiety. For a long time, people have been taught to think of fat as a bad thing and to consume as little of it as possible. The teachings of Dr. Dean Ornish and the very low-fat, high-carbohydrate diet (i.e., less than 10% of daily intake from fat) were drilled into people's heads since the late 1970's in an effort to prevent cardiovascular disease. However, the nutrition world is beginning to change and shift the nutrition paradigm to include fat and to respect fat's place in the human diet. The direct correlation of saturated fat intake to cardiovascular disease is being challenged. Studies are not suggesting that, when all dietary influences are held constant, there is no significant evidence that dietary saturated fat intake is associated with an increased risk of coronary heart disease or cardiovascular disease. Therefore, fat should not be avoided, but rather encouraged in moderation as an essential part of a healthy, well-balanced diet.

Carbohydrates provide a quick energy source to the body. Simple carbohydrates include fructose, glucose, galactose (simple sugars, also known as monosaccharides and disaccharides), which are absorbed directly into the blood stream during digestion (e.g., honey, tree and vine fruits, berries, root vegetables, sugar cane, sugar beets, maize), and high-fructose corn syrup (HFCS), which is a mixture of fructose and glucose used to sweeten products to increase the palatability of food. On the other hand, complex carbohydrates (i.e., polysaccharides or oligosaccharides) are typically characterized by a whole food, where fiber, vitamins, and minerals are also a part of the food itself. Notably, however, complex carbohydrates do not always denote the rate at which these carbohydrates get absorbed into the blood stream. Complex carbohydrates may just as quickly and easily be absorbed into the blood stream as simple carbohydrates. The rate of absorption depends on many other factors, including other nutrients that are consumed with the carbohydrate (e.g., fat, protein, fiber), how the food is prepared, and the actual chemical bonds and makeup of the carbohydrate itself. When consumed in excess and not efficiently burned as fuel (e.g., through daily physical activity, such as endurance activity), carbohydrates are stored as fat by the body in the form of triglycerides, contributing to artery clogging and linked to an increased risk of heart disease.

Potential features of desirable exercise may include, without limitation:
Burning more energy (fuel) than the person intakes;
Increased physical activity to build lean body mass, which is more metabolically active (i.e., burns energy/calories/fuel at a higher rate) than fat mass; and/or
Cardiovascular and strength training, which increases the person's proportion of lean body mass to fat mass, thereby increasing the person's metabolism.

With respect to genetics, a person is born with an established number of fat cells—generally, by the age of two. This is the person's genetic predisposition for fat cells. It is up to the person to determine how to fill that established number of fat cells.

With respect to body mass, an increased lean body mass or fat mass ratio enables a higher resting metabolic rate. This is due to the fact that lean tissue is more metabolically active than fat tissue. Therefore, all other things being equal, for the same amount of work (e.g., exercise), a person with a higher lean body mass will burn more calories than a person with a lower lean body mass or higher fat mass.

System Overview

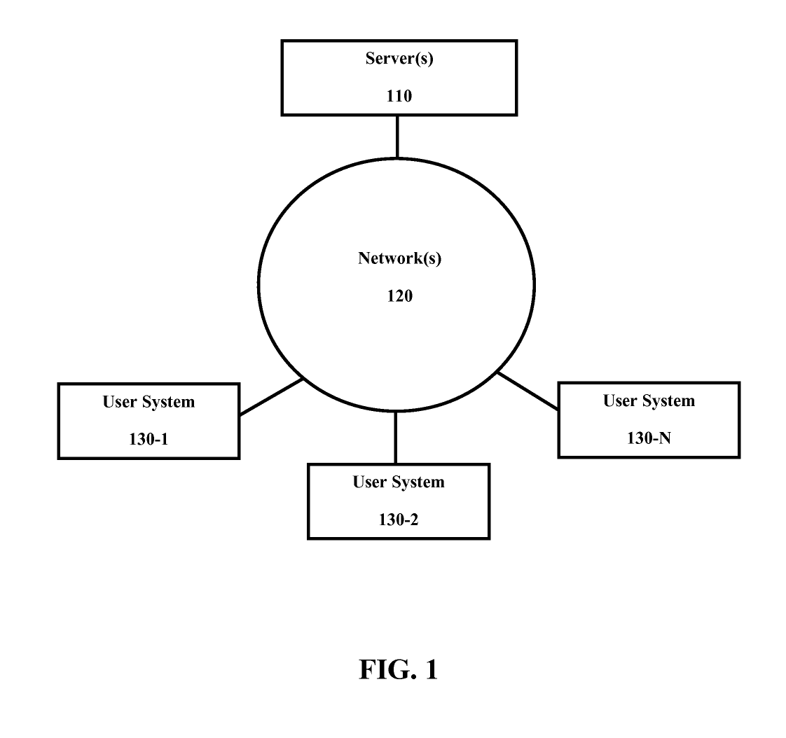

FIG. 1 illustrates an example of a distributed, network-based system for health management, according to an embodiment. The system may comprise a set of one or more servers 110 (also referred to herein as a “platform”) which host and/or execute one or more of the various functions, processes, and/or modules described herein. In addition, server(s) 110 may be communicatively connected to one or more user systems 130 via one or more network(s) 120. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. It should also be understood that server(s) 110 may be, but are not required to be, collocated. Furthermore, while server(s) 110 are illustrated as being connected to various systems through a single set of network(s) 120, it should be understood that the server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, and the like. In addition, while only a few user systems 130 and one set of server(s) 110 are illustrated, it should be understood that the network may comprise any number of user systems and sets of server(s).

Platform 110 may comprise web servers which host one or more websites or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to platform 110. Platform 110 may also respond to other requests from user system(s) 130.

Platform 110 may further comprise, be communicatively coupled with, or otherwise have access to one or more database(s). For example, platform 110 may comprise one or more database servers which manage one or more databases. A user system 130 or application executing on platform 110 may submit data (e.g., user data, form data, etc.) to be stored in the database(s), and/or request access to data stored in such database(s). Any suitable database may be utilized, including without limitation MySQL™, Oracle™, IBM™, Microsoft SQL™, Sybase™, Access™, and the like, including cloud-based database instances. Data may be sent to platform 110, for instance, using the well-known POST request supported by HTTP, via FTP, etc. This data, as well as other requests, may be handled, for example, by server-side web technology, such as a servlet or other software module, executed by platform 110.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130, which may themselves be servers, can define their own user interfaces, and rely on the web service to implement the backend processes, functionality, storage, etc., described herein. For example, in such an embodiment, a client application executing on one or more user system(s) 130 may interact with a server application executing on platform 110 to execute one or more or a portion of one or more of the various functions, processes, and/or software modules described herein. The client application may be “thin,” in which case processing is primarily carried out server-side by platform 110. A simple example of a thin client application is a browser application, which simply requests, receives, and renders web pages at user system(s) 130, while platform 110 is responsible for generating the web pages and managing database functions. Alternatively, the client application may be “thick,” in which case processing is primarily carried out client-side by user system(s) 130. For example, server(s) 110 may simply comprise database server(s) which provide storage and database management functions, while user system(s) 130 provide all of the other disclosed functionality. It should be understood that the client application may perform an amount of processing, relative to platform 110, at any point along this spectrum between “thin” and “thick,” depending on the design goals of the particular implementation. In any case, the application, which may wholly reside on either platform 110 or user system(s) 130 or be distributed between platform 110 or user system(s) 130, can comprise one or more executable software modules that implement one or more of the processes or functions of the application(s) described herein.

In an alternative embodiment to the network-based system illustrated in FIG. 1, the processes discussed herein may be implemented as a stand-alone application that may reside and be executed or otherwise utilized on a single device, such as a desktop computer or mobile device (e.g., tablet computer, smart phone, etc.). In such an embodiment, all data may be stored and processed locally on the device. However, it should be understood that, even in such stand-alone embodiments, the application may be downloaded and updated from server(s) 110 via network 120.

It should be further understood that any of the data described herein as being accessed, retrieved, stored, etc. may reside on a database of user system(s) 130 and/or a database of server(s) 110 and may be accessed by modules of user system(s) 130, modules of server(s) 110, or modules of both user system(s) 130 and server(s) 110. For instance, in embodiments in which the application comprises a stand-alone application executing on a user system 130 or server(s) 110, application modules may store and access data in a local memory of user system 130 or server(s) 110, respectively. As another example, in embodiments in which the application comprises a distributed application, application modules of a client application on a user system 130 may store and/or access data in a remote memory of server(s) 110 (e.g., via network(s) 120) and/or in a local memory of user system 130.

Process Overview

In an embodiment, the method utilizes an index that represents a combination of nutritional values. The index can be used to facilitate the reduction of caloric intake, the maintenance or increase of metabolism, and the reduction of appetite (which, in turn, makes it easier to reduce caloric intake). The index computation may account for appetite, caloric intake, metabolism, and/or general cardiovascular health, and may utilize any number of nutrition-related variables for healthy weight management. For instance, the index computation may comprise one or more mathematical operations on all or a subset of common nutritional information generally available for food products, such as carbohydrates, protein, fat, calories, and/or fiber. Additionally or alternatively, other nutritional parameters may be used, such as sodium, sugar, and/or certain vitamins and minerals.

In an embodiment, more than one index may be provided or utilized. Each index may comprise a mathematical combination of two or more unweighted or weighted variables. A first index may be used for a quick and easy assessment, while a second index may be used as a more comprehensive measure of a food product's ability to help an individual reduce appetite and caloric intake. In different embodiments, the disclosed systems and methods may utilize only the first index, only the second index, or both indices.

In an embodiment, the first index may comprise a ratio or other mathematical combination of calorie and protein values. This mathematical combination may be simple enough to be roughly, but manually, performed by a human, thereby providing a quick and easy way of assessing the weight-management or other health value of a food product. According to an embodiment, the first index may be calculated according to Equation 1 below:

$$\frac{Calories}{Protein} \qquad Equation 1$$

It should be understood that that the variables Calories and Protein may be provided in or converted to any suitable unit of measure. In an embodiment, each of these variables may be converted to a standard unit that is utilized for all calculations using Equation 1. For instance, Calories may be converted to calories (cal), if not already provided in calories, and Protein may be converted to grams (g), if not already provided in grams. The exact units of measure used are not critical to the disclosed method, as long as the units are kept consistent across calculations of the first index for all food products. In other words, the exact units of measure used are not essential as long as the index calculated for one food product can be easily and appropriately compared to the index calculated for a different food product.

In an embodiment, the second index may comprise a ratio, combination of ratios, or other mathematical combination of calories, carbohydrates, saturated fats, unsaturated fats, and protein, and the like (e.g., fiber, good carbohydrates, bad carbohydrates, sodium, etc.). Each of these variables has an important place in the maintenance of a person's health, metabolism, appetite, and weight. For instance, some fat is necessary, and saturated fats can help reduce appetite, but must be appropriately balanced with adverse cardiological effects. According to an embodiment, the second index may be calculated according to Equation 2 below:

$$\frac{( \frac{Calories \times Carbohydrates}{( \frac{Saturated Fats}{Unsaturated Fats} )} )}{Protein} \qquad Equation 2$$

The second index according to Equation 2 includes more nutritional variables than the first index according to Equation 1, and thus, may provide a more informative assessment of a food product's nutritional contribution to health or weight management. As with the first index, it should be understood that each of the variables may be provided in or converted to any suitable unit of measure, and the exact units of measure used are not critical to the disclosed method, as long as those units are kept consistent across calculations of the second index for all food products. In embodiments which utilize both the first index and the second index, it may be useful to ensure that the Calories and Protein variables used in both the first index and the second index utilize the same units of measurement. For instance, in both indices, Calories and Protein may be input into the relevant equation in calories and grams, respectively. In addition, in the second index, Carbohydrates, Saturated Fats, and Unsaturated Fats may each be input into Equation 2 in grams.

As mentioned above, the first index provides a rough estimate of the contribution of a food product to health management, whereas the second index provides a more refined estimate of the contribution of a food product to health management. However, both indices incorporate a ratio based on calories over protein. While a basic tenet of weight management is to select low-calorie food products, this is not sufficient alone for weight loss. For instance, if the selected food product contains little or no protein, a person may be get hungry again soon after consumption of the food product, thereby causing the person to eat again and increasing his or her caloric intake. Accordingly, both the first index and the second index also utilize protein, which, among other things, accounts for a food product's effect on appetite.

The values for the first index and/or second index may be provided as a unitless value. In an embodiment, the particular units for these index values are not important, as long as each are calculated in the same units, so as to be readily comparable.

It should be understood that, generally speaking, the lower the value of either the first index or the second index, the better a food product is for health or weight management. For instance, the following table represents example computations of Equation 1 and Equation 2 for some sample food products, according to an embodiment:

| | | | | Sat. | Unsat. | | |
|---|---|---|---|---|---|---|---|
| Food Product | Cal. | Protein | Carb. | Fat | Fat | Eq. 1 | Eq. 2 |
| Goose Liver | 133 | 16.37 | 6.32 | 1.59 | 1.07 | 8.12 | 34.55 |
| Duck Meat | 135 | 18.28 | 0.94 | 2.32 | 2.29 | 7.39 | 6.85 |
| Turkey Heart | 140 | 16.7 | 0.4 | 1.923 | 4.198 | 8.38 | 7.32 |
| Raisin Bread | 274 | 7.9 | 52.3 | 1.081 | 2.973 | 34.68 | 4988.78 |

As illustrated, in some instances, the first index may comprise a higher value than the second index (e.g., duck meat), but in other instances, the first index may comprise a lower value than the second index (e.g., goose liver). However, in either case, the lower the index value, the better the nutritional contribution provided by the food product. For example, it can be seen from the example values that, according to either index, duck meat provides a better nutritional contribution than turkey heart.

While the first index and/or second index may be described as the numerical result of solving one of the disclosed equations, it should be understood that the indices may not necessarily correspond exactly with this numerical result, but instead be derived from this numerical result. For instance, either index value may be represented as a rounded decimal number (e.g., to two decimal places), be rounded to the nearest integer, always rounded down to the nearest integer, always rounded up to the nearest integer, etc. Alternatively, either index value may indicate one of a plurality of nutritional tiers (e.g., where each tier reflects a range of values calculated using the relevant equation) to which a food product belongs. In this manner, all food products can be assigned to one of a plurality of tiers.

For example, the possible range of index values may be divided into five ranges which are each associated in one-to-one correspondence with a different tier. Thus, any index value can be categorized into one of five tiers, such that any index value can be converted into one of five designations, such as the numbers one through five. Consequently, a point system can be used in which any food product can be converted into a number of points between and including one and five. It should be understood that other point scales are possible, such as one to ten, “A” to “E”, or any other spectrum of designations.

These points can then be used to build an appropriate or desired diet. For example, a user may attempt to keep the total number of points, representing all food products consumed during a day or other time period, under a target threshold. A plurality of target thresholds may be provided and available to a user depending on the user's physical attributes (e.g., height, weight, age, gender, body type, activity level, etc.) and/or diet goals (e.g., weight loss, weight gain, weight maintenance, healthy eating, muscle building, cardiovascular health, etc.).

It should also be understood that, in some instances, Equations 1 and 2 may result in a value of zero or a division by zero. If the value is zero, it may be converted to a different value (e.g., one) or the value of the variable that results in the zero value may be converted to a different value (e.g., one). Similarly, if the equation results in a division by zero, the result of the equation may be converted to a predetermined value (e.g., one) or the value of the variable that results in the division by zero (i.e., a zero value of, e.g., protein, saturated fat, or unsaturated fat) may be converted to a different value (e.g., one). These are simply illustrative examples of how to address these instances, in embodiments which do address these instances, and should not be construed as limiting in any way.

Advantageously, the described indices, either alone or in combination, allow a person to quickly determine how a food item may contribute (either positively or negatively) to weight loss. For instance, the indices allow a person to simultaneously assess how a food product may affect their metabolism, appetite, and caloric intake. It should be understood that one or both of the disclosed indices can be used to supplement existing dieting methods (e.g., exercise routines, Jenny Craig™, Weight Watchers™, etc.) to enhance their effectiveness. In addition, food sources (e.g., producers, manufacturers, restaurants, etc.) can use one or both of the indices to inform and assist consumers in making the best choices for healthy eating, weight management, and the like.

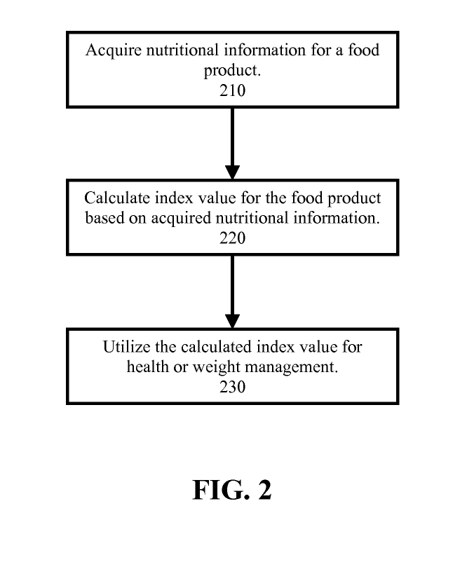

In an embodiment, one or both of the indices may be utilized by a stand-alone or distributed application, as discussed above. The application may comprise one or more modules associated with one or more of the disclosed functions. FIG. 2 illustrates some of these functions, according to an embodiment.

Initially, in step 210, the application acquires or receives an input of nutritional information for one or more food products. This nutritional information may include, without limitation, calories, protein, carbohydrates, saturated fat, and/or unsaturated fat for each food product. The nutritional information may be input by a user (e.g., using a mouse, keyboard, touchscreen, etc.) into one or more inputs in one or more user interfaces provided by the application. Alternatively or additionally, the nutritional information may be captured via an optical device or other acquisition device.

For example, the application may comprise or be interfaced with a module that resides on a client device (e.g., smart phone) and interfaces with a camera (or other device) of the client device to acquire an image of nutritional information associated with a food product (e.g., provided on product packaging, a label, or a nutritional guide) and/or acquire an image of or otherwise read a barcode associated with a food product (e.g., provided on product packaging or a nutritional guide).

In embodiments which are able to acquire an image of nutritional information, the application may comprise a module that implements optical character recognition (OCR) to convert the image into one or more character strings (e.g., alphanumeric character string). These characters may then be parsed to identify references to nutritional variables and their values. For example, the characters may be parsed to identify the term “calories” and a numerical value associated with (e.g., following) the identified term “calories.” All of the characters may be parsed until values are identified for one or more of calories, protein, carbohydrates, saturated fat, unsaturated fat, and the like.

In embodiments which acquire a barcode, the application may comprise a module that is able to decode the barcode into a character string (e.g., alphanumeric character string). Generally, barcodes on product packaging represent an identification of the product. Thus, in such embodiments or scenarios, the character string, decoded from the barcode, can be used to retrieve nutritional information associated with product. For instance, the application may use the character string, a portion of the character string, or a value derived from the character string to generate a query to retrieve the nutritional information from a local database (e.g., in a memory of a mobile device, such as user system 130, executing the application) or from a remote database (e.g., by directly or indirectly accessing a memory of server(s) 110 over network(s) 120). Alternatively, the character string may represent or comprise a Uniform Resource Locator (URL) for directly retrieving the nutritional information, for example, from server(s) 110 over network(s) 120.

In step 220, the application calculates one or more of the disclosed indices based on the nutritional information acquired in step 210. For instance, the application may comprise a module which receives a portion or all of the nutritional information as one or more input values, calculates a solution to one or both of Equation 1 and Equation 2 using the input values, and outputs the result(s) of the calculation(s) or a value derived from the result(s) of the calculation(s). For instance, the module may receive the values of calories and protein, obtained from the acquired nutritional information for a food product, as an input, and provide the result of Equation 1 or a value derived from the result of Equation 1 as an output index value. Alternatively or additionally, the module may receive the values of calories, carbohydrates, saturated fat, unsaturated fat, obtained from the acquired nutritional information for a food product, as an input, and provide the result of Equation 2 or a value derived from the result of Equation 2 as an output index value. In one embodiment, the application may generate an error or other notification if it is not able to acquire sufficient nutritional information for calculating an index or if an index cannot be calculated.

In step 230, the calculated output value(s) may be utilized by one or more additional modules for health or weight management. For example, a module may display the output index value(s) to a user, thereby allowing the user to evaluate the food product (e.g., while making a decision as to whether or not to purchase the food product). In this manner, a user can be provided with an immediate assessment of a food product that they are about to purchase or consume or have already consumed.

Additionally or alternatively, a module may track or store the index value(s) (e.g., automatically or in response to a user operation) using either a local database on user system(s) 130 or a remote database on server(s) 110. The stored index value(s) can be used as part of a health or weight management scheme. For example, the stored index value(s) may be summed for one or more time intervals, and the application may store a threshold index value for the one or more time intervals. The threshold index value may represent a goal for a user of the application to strive towards. For instance, the threshold index value may represent an upper limit of a healthy accumulation of index value(s) for a given time interval, such as a day, week, month, year, etc. Thus, the goal for the user is to prevent the sum of his or her index value(s) accumulated for a given time interval to exceed the threshold index value for that time interval. The application may display the sum of the index value(s) as well as threshold index value for a given time interval, as well as provide the user with tools (e.g., graphs, charts, alerts) to help him or her achieve the goal for the time interval. Thus, the user can keep track of the total index amounts consumed over a time interval (e.g., day, week, month, year, etc.).

In addition, it should be understood that the application may track not just index values, but also the nutritional variables that have been acquired in step 210. For instance, the application may comprise a module that tracks the number of calories, carbohydrates, protein, saturated fat, unsaturated fat, and the like consumed over one or more time intervals (e.g., day, week, month, year, etc.). The application may also comprise a module which tracks user-specific variables (e.g., input by a user) over one or more time intervals. These user-specific variables may include weight, body fat percentage, etc., and may also include static or near-static metrics or values as well (e.g., height, date of birth, gender, etc.). Thus, as an example, the application may comprise a module which allows a user to view a measure of caloric intake versus weight loss over a time interval (e.g., day, week, month, year, etc.), thereby providing an indirect assessment of a user's metabolism. Advantageously, such a measure can help a user adjust his or her intake of certain food components (e.g., calories, carbohydrates, protein, saturated fat, unsaturated fat, etc.), based upon those components' effects on the user's metabolism (as represented by one or both of the disclosed indices).

Example Processing Device

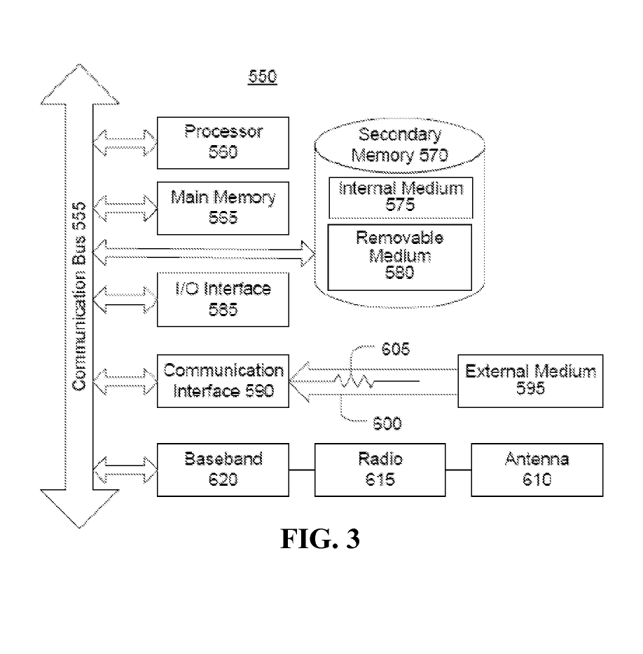

FIG. 3 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor to:
acquire nutritional information for a food product, wherein the nutritional information comprises a calorie value and a protein value;
compute at least one index value for the food product based on the calorie value and the protein value; and
provide one or more weight management tools to a user based on the computed index value.

2. The method of claim 1, wherein computing the at least one index value comprises calculating a ratio of the calorie value to the protein value.

3. The method of claim 1, wherein the nutritional information further comprises a carbohydrate value, a saturated fat value, and an unsaturated fat value, and wherein computing the at least one index value for the food product is based on the calorie value, the protein value, the carbohydrate value, the saturated fat value, and the unsaturated fat value.

4. The method of claim 3, wherein computing the at least one index value comprises:
multiplying the calorie value by the carbohydrate value to obtain a first value;
dividing the saturated fat value by the unsaturated fat value to obtain a second value;
dividing the first value by the second value to obtain a third value; and
dividing the third value by the protein value to obtain a fourth value.

5. The method of claim 4, wherein the at least one index value is based on the fourth value.

6. The method of claim 5, wherein the at least one index value comprises the fourth value.

7. The method of claim 1, wherein acquiring nutritional information for a food product comprises:
acquiring a digital image of the nutritional information;
applying optical character recognition to the digital image of the nutritional information to obtain the calorie value and the protein value.

8. The method of claim 1, wherein acquiring nutritional information for a food product comprises:
decoding information from a barcode associated with the food product; and
retrieving the nutritional information from at least one database based on the decoded information.

9. The method of claim 8, wherein retrieving the nutritional information from at least one database comprises retrieving the nutritional information from at least one remote database over at least one network.

10. The method of claim 1, wherein the one or more weight management tools comprise a sum of accumulated index values, calculated for a plurality of food products, over at least a portion of a time interval, and a comparison of the sum to a threshold value for the time interval.

11. A system comprising:
at least one hardware processor; and
at least one executable software module that is configured to, when executed by the at least one hardware processor,
acquire nutritional information for a food product, wherein the nutritional information comprises a calorie value and a protein value,
compute at least one index value for the food product based on the calorie value and the protein value, and
provide one or more weight management tools to a user based on the computed index value.

12. The system of claim 11, wherein computing the at least one index value comprises calculating a ratio of the calorie value to the protein value.

13. The system of claim 11, wherein the nutritional information further comprises a carbohydrate value, a saturated fat value, and an unsaturated fat value, and wherein computing the at least one index value for the food product is based on the calorie value, the protein value, the carbohydrate value, the saturated fat value, and the unsaturated fat value.

14. The system of claim 13, wherein computing the at least one index value comprises:
multiplying the calorie value by the carbohydrate value to obtain a first value;
dividing the saturated fat value by the unsaturated fat value to obtain a second value;
dividing the first value by the second value to obtain a third value; and
dividing the third value by the protein value to obtain a fourth value.

15. The system of claim 14, wherein the at least one index value is based on the fourth value.

16. The system of claim 15, wherein the at least one index value comprises the fourth value.

17. The system of claim 11, wherein acquiring nutritional information for a food product comprises:
acquiring a digital image of the nutritional information;
applying optical character recognition to the digital image of the nutritional information to obtain the calorie value and the protein value.

18. The system of claim 11, wherein acquiring nutritional information for a food product comprises:
decoding information from a barcode associated with the food product; and
retrieving the nutritional information from at least one database based on the decoded information.

19. The system of claim 18, wherein retrieving the nutritional information from at least one database comprises retrieving the nutritional information from at least one remote database over at least one network.

20. The system of claim 11, wherein the one or more weight management tools comprise a sum of accumulated index values, calculated for a plurality of food products, over at least a portion of a time interval, and a comparison of the sum to a threshold value for the time interval.
